(19) United States
(12) Patent Application Publication
(10) Pub. No.: US 2021/0317921 A1
(43) Pub. Date: Oct. 14, 2021

(54) SAFETY VALVE AND RADIATOR USING SUCH SAFETY VALVE

(71) Applicant: Athena S.P.A., Alonte (VI) (IT)

(72) Inventor: Manuele Guarda, Montecchio Maggiore (IT)

(21) Appl. No.: 17/270,709

(22) PCT Filed: Sep. 27, 2019
(86) PCT No.: PCT/IB2019/058227

§ 371 Date: Feb. 23, 2021

(30) Foreign Application Priority Data
Sep. 27, 2018 (IT) 102018000008984

(51) Int. Cl. F16K 15/02; F16K 17/04

(52) U.S. Cl. CPC F16K 15/026; F16K 17/04

(57) ABSTRACT

A safety valve particularly adapted to be applied to equipment containing a pressurized fluid that includes a tubular sleeve in which the following are identified: a tubular body provided with an inlet hole and an outlet hole of the pressurized fluid; a shutter unit of the inlet hole slidably housed within the tubular body and disposed between the inlet hole and the outlet hole; and a retainer of the shutter unit present at the outlet hole. The safety valve also includes a tubular flange belonging to the tubular body, arranged coaxially and radially distanced externally to the outlet hole and provided internally with a shaped zone arranged coaxially and above the retainer and configured to house a manoeuvring key.

### BACKGROUND OF THE INVENTION

### 1. The Field of the Invention

The invention concerns a safety valve for equipment containing pressurized fluid, particularly suitable for application to horizontal or vertical wall mounted radiators of the ladder type.

The invention also relates to a wall mounted radiator that uses the aforesaid safety valve.

### 2. The Relevant Technology

As is known, safety valves are applied to systems and equipment containing pressurized fluid and intervene by discharging into the surrounding environment any excess pressure that may arise in the system.

For that purpose, safety valves contain within them a shutter that can be calibrated which enables the opening thereof when the pressure within the system exceeds the calibration pressure of the shutter.

The valves are also provided with an outer thread that enables it to be screwed into a corresponding threaded hole realized passing into the pressurized body and a discharge conduit which in the event of intervention of the valve conveys the overpressurized fluid into the external environment.

A valve of the mentioned type is described in patent document EP1857745 and relates to a safety valve that is applied to radiators of the ladder type.

The valve is provided with a thread that enables it to be applied to the radiator and in the upper part with a rotatable cap in which the lateral overpressure discharge conduit is made.

By rotating the rotatable cap the discharge conduit can therefore be turned in the most appropriate direction so that in the event of intervention of the valve, the fluid that is discharged does not damage the walls and/or things and/or people present nearby.

The aforesaid valves however have the drawback that for some system situations lateral discharge, whichever way it is oriented, may not be acceptable.

Furthermore, the rotatable cap is placed above the threaded zone of the valve and, when it is installed, the cap projects anti-aesthetically from the top part of the radiator, and this constitutes a second drawback of such known valves.

Safety valves are also known such as, for example, the safety valve described in patent document CH557493 which, when installed, does not project from the top part of the pressurized body to which it is applied but has the drawback that the shutter is in direct contact with the external environment and in the event of intervention it even projects outside.

### SUMMARY OF THE INVENTION

The present invention intends to overcome the listed drawbacks.

In particular, it is an object of the present invention to realize a safety valve that has the overpressure discharge conduit oriented according to the longitudinal axis of the valve.

It is another object that the valve shutter is totally contained in the valve body both when it is in the closed position, and when it is in the open position.

It is a further object that the valve of the invention is provided with manoeuvring means adapted to apply it to the related pressurized body, arranged within a valve body and accessible from the outside through a manoeuvring member.

It is another object that the end of the valve body in which the manoeuvring means is present is configured so as to be totally housed in the seat of the pressurized container to which the valve is applied.

The listed aims are reached by a safety valve having the characteristics according to the main claim to which reference will be made.

Further characteristics of the valve of the invention are described in the dependent claims.

The safety valve of the invention is advantageously used in heating systems and particularly is applied to wall mounted radiators of the ladder type as, when it is installed, it does not have any part projecting from the outer profile of the radiator.

Furthermore, advantageously, the direction of the discharge arranged according to the longitudinal direction of the valve reduces the possibility of damage in the surrounding environment in the event of discharge due to overpressure.

Finally, advantageously, the safety valve according to the invention can be installed instead of the safety valves with lateral discharge of existing systems, as it can be housed in the same housing and thus improve the aesthetic and functional characteristics of such systems.

### BRIEF DESCRIPTION OF THE DRAWINGS

The aims and advantages listed and any others shall be better highlighted below during the description of a preferred but not exclusive embodiment of the invention, which is provided with reference to the appended drawings in which:

FIG. 1 represents an axonometric view of the safety valve of the invention;

FIG. 2 represents the exploded axonometric view of FIG. 1;

FIG. 3 represents the longitudinal section of FIG. 1;

FIG. 4 represents the exploded view of FIG. 3;

FIG. 5 represents a wall mounted radiator in which the safety valve according to the invention is installed;

FIG. 6 represents an enlarged detail of FIG. 5;

FIG. 7 represents a safety valve with lateral discharge pertaining to the prior art;

FIG. 8 represents the plan view of FIG. 7.

### DETAILED DESCRIPTION OF THE PREFERRED EMBODIMENTS

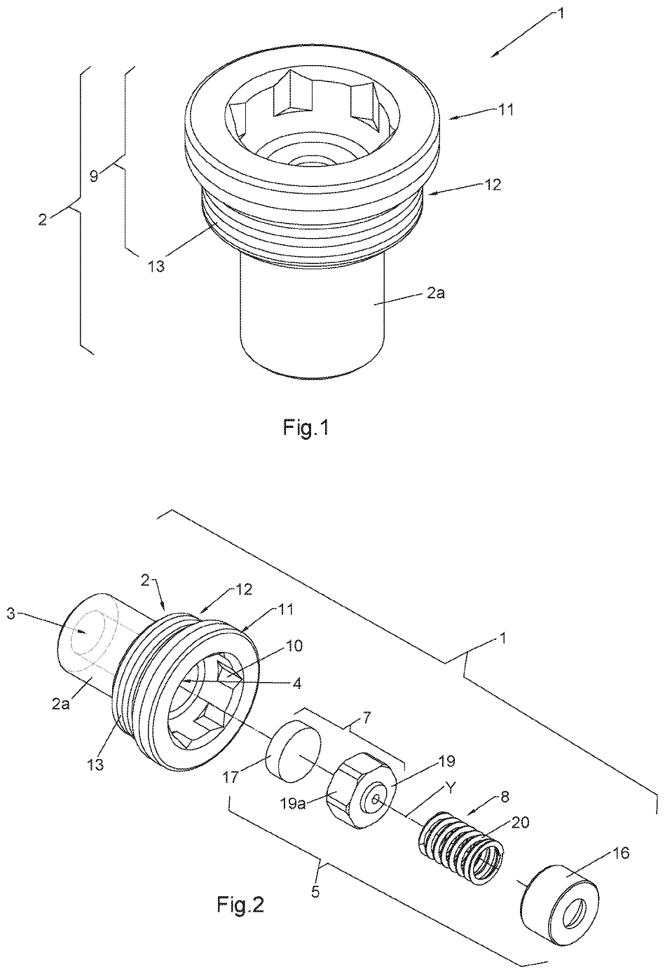

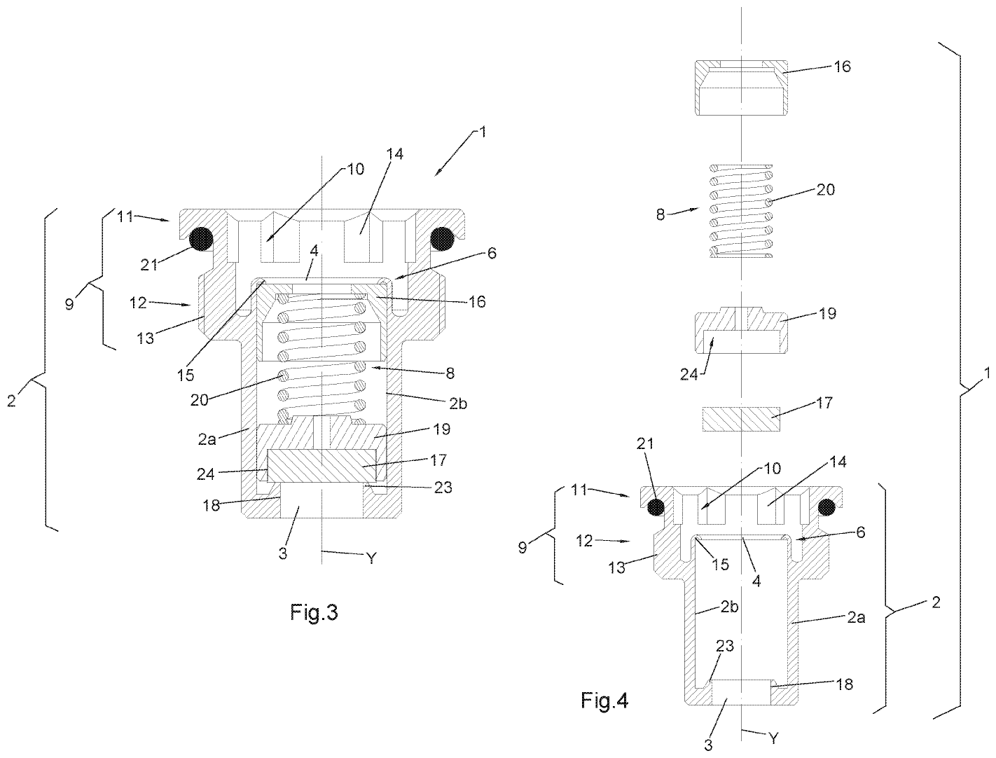

The safety valve of the invention is represented in an axonometric view in FIG. 1 and in a longitudinal section in FIG. 3 where it is indicated overall with 1.

The safety valve 1 of the invention is also represented in an exploded axonometric view in FIG. 2 and in an exploded longitudinal section in FIG. 4.

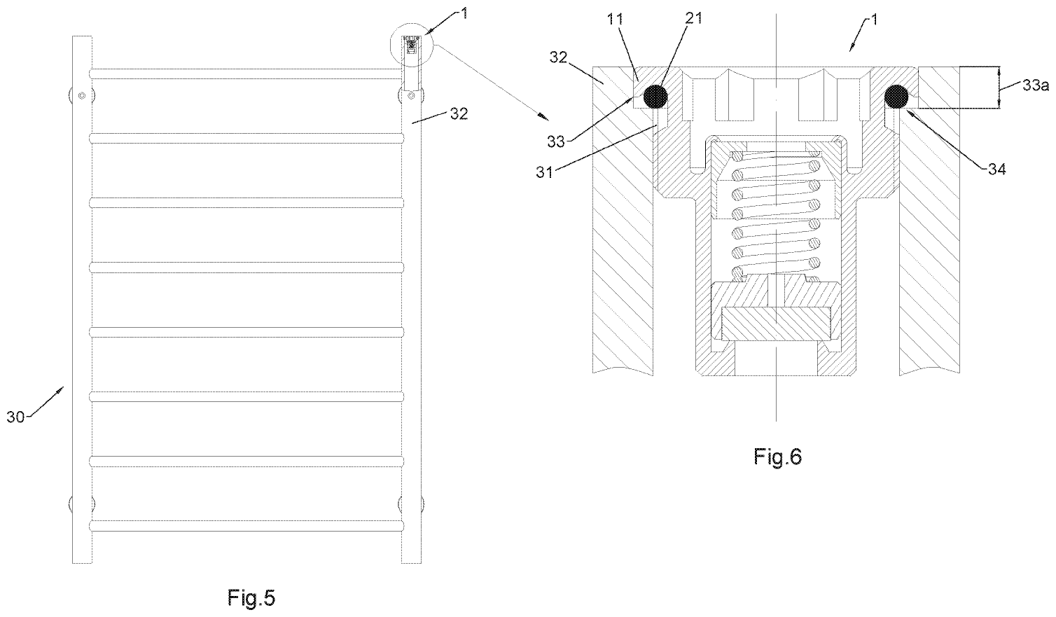

The valve 1 is particularly adapted to be applied to equipment containing pressurized fluids and particularly wall mounted radiators, e.g., to the radiator of the type represented schematically in FIG. 5 and indicated with 30.

The safety valve 1, as can be observed, comprises a tubular sleeve 2 which defines a longitudinal axis Y and in which a tubular body 2a is identified provided with an inlet hole 3 and an outlet hole 4 of the pressurized fluid.

There is also a shutter unit 5 of the inlet hole 3 which is slidably housed in the tubular body 2a and is comprised between the inlet hole 3 and the outlet hole 4. There are also retaining means of the shutter unit 5, indicated overall with 6, which are present at the outlet hole 4.

According to the invention, the safety valve 1 also comprises a tubular flange 9 which belongs to the tubular body 2a and is arranged coaxially and radially distanced externally to the outlet hole 4.

Furthermore, the tubular flange 9 is internally provided with a shaped zone 10 arranged coaxially and distanced above the retaining means 6, which is configured to house a manoeuvring key from the outside.

In relation to the shutter unit 5 it is observed, with particular reference to the exploded views of FIG. 2 and FIG. 4, that it comprises a shutter 7 configured to cooperate with the inlet hole 3 of the tubular body 2a and elastic means 8 which are interposed between the shutter 7 and the retaining means 6 and are adapted to keep the shutter 7 in the position in which it normally closes the inlet hole 3, as can be observed in FIG. 3.

With regard, instead, to the tubular flange 9 it is observed that it comprises an annular perimeter edge 11 in which said shaped zone 10 is present, and an annular strip 12, comprised between the tubular body 2a and the annular perimeter edge 11, which is arranged peripherally and radially distanced from the outlet hole 4 and from the retaining means 6.

Furthermore, there is also a threaded zone 13 realized outside the annular strip 12 which is used to couple the safety valve 1 to the radiator 30 of FIG. 5 in the respective threaded hole 31 that can be observed in FIG. 6 or in another pressurized body.

The shaped zone 10 is therefore arranged coaxially and distanced above the annular strip 12 and the retaining means 6 which therefore do not hinder the manoeuvring key from being inserted in the shaped zone 10 for screwing or unscrewing the valve 1.

It is also observed that the inlet hole 3, the outlet hole 4 and the tubular body 2a in which said holes are present are coaxial to one another according to the longitudinal axis Y defined by the tubular manifold 2.

In this way, the direction of the fluid exiting the valve 1 in the event of overpressure is a rectilinear flow in the upwards direction which, unlike the valves with lateral discharge of the prior art, does not damage walls and/or things and/or people present near the equipment to which the safety valve is applied.

In particular, the shaped zone 10 has a female polygonal profile 14 preferably with a hexagonal shape, configured to receive the insertion of a manoeuvring key also having a male polygonal profile, preferably hexagonal.

With regard to the retaining means, indicated overall with 6, they comprise a retaining edge 15 which is realized in the tubular body 2a and projects towards the inside of the outlet hole 4 and a retaining ring 16 which is arranged inside the tubular body 2a and is placed next to the retaining edge 15.

In particular, the retaining edge 15, although not represented in the figures, is obtained by folding the end edge of the outlet hole 4 towards the inside of the hole itself through a so-called centring operation well known in the sector of processing metals by plastic deformation.

In relation to the shutter 7 it is observed that it comprises a sealing gasket 17, which is placed in contact with a sealing edge 18 realized in the tubular body 2a and facing towards the inside of the inlet hole 3.

The shutter 7 also comprises a gasket holder 19 which is provided with an internal seat 24 in which the sealing gasket 17 is housed and is slidably associated internally with the tubular body 2a where it is arranged between the sealing gasket 17 and the elastic means 8.

In particular, the sealing edge 18 has a shaped profile turned towards the inside of the tubular body 2a which has the vertex 23 in contact with the sealing gasket 17.

In this way, the sealing edge 18 penetrates into the sealing gasket 17 which is preferably made of plastic or elastomeric material guaranteeing the seal.

It is also observed that the gasket holder 19 has a polygonal external profile 19a, whereas the tubular body 2a has an internal cross section with a circular shape.

This configuration is important as, in the event of overpressure, the overpressurized fluid causes the compression of the elastic means 8 and the lifting of the gasket holder 19 with the related sealing gasket 17, and flows through the inlet hole 3. The fluid then expands into the tubular body 2a until it spontaneously reaches the outlet hole 4 passing between the internal wall 2b of the tubular body 2a and the flat faces that delimit the external profile 19a of the gasket holder 19.

Finally, in relation to the elastic means 8 they may be made in different ways, but they preferably comprise a helical spring 20.

Finally, to obtain the seal with respect to the pressurized body to which the safety valve 1 is applied, e.g., with respect to the wall mounted radiator 30 represented in FIG. 5, the valve is provided with an annular seat 33 which is observed in particular in FIG. 6 which is realized circumferentially outside the tubular flange 9 at the annular perimeter edge 11 and is configured to house a sealing ring 21 preferably of the OR type.

Operatively, as already mentioned, a valve 1 of the invention is applied to a radiator of the wall-mounted type, indicated overall with 30 in FIG. 5, to which it is screwed in a threaded hole 31 present in one or in both of the upright columns 32.

For that purpose, it is observed in the enlargement of FIG. 6 that in the upright column 32 a seat 33 is realized which houses the annular perimeter edge 11 of the valve and that has a shoulder 34 on which the sealing ring 21 goes into contrast when the valve 1 is screwed into the threaded hole 31.

It is observed that the height 33a of the seat 33 is such as to contain the whole annular perimeter edge 11 when the valve 1 is screwed.

In this way, there is no projection present from the top zone of the radiator 30, as can be observed in FIG. 5, unlike what happens in the prior art, e.g., when lateral discharge valves are used of the type described in the mentioned patent document EP1857745.

The safety valve 1 of the invention is advantageously adapted to replace the lateral discharge valves of the type described in the mentioned patent document EP1857745.

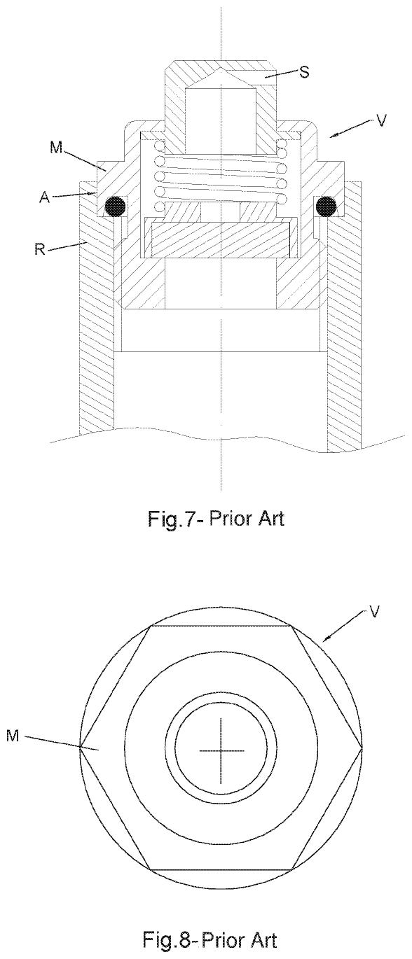

For that purpose, a known valve realized according to the teachings of document EP1857745 is represented in the two views of FIGS. 7 and 8 where it is indicated overall by V and where it is observed that it has the upper part in which the orientable lateral discharge S is realized and part of the manoeuvring profile M which project from the seat A and therefore also from the top of the radiator R to which it is applied.

It is easy to understand that the safety valve V of the prior art can be advantageously replaced with the valve 1 of the invention as the same seat A can completely house the annular perimeter edge 11 of the valve 1 of the invention so as to prevent any anti-aesthetic projection from the top of the radiator R.

Therefore, in pressurized containers R of the type represented in FIG. 7 provided with safety valves V of the prior art, these may be advantageously and easily replaced with the valves 1 of the invention.

Based on the above, it is thus clear that the safety valve according to the invention reaches all the prefixed aims.

In the operation stage, modifications or variants not described and not represented in the figures may be made to the valve of the invention, and should such modifications or variants be contained within the descriptive scope of the following claims, they must absolutely all be considered protected by the present patent.

1. A safety valve, particularly adapted to be applied to equipment containing a pressurized fluid and comprising a tubular sleeve that defines a longitudinal axis and in which the following are identified:
a tubular body provided with an inlet hole and an outlet hole of said pressurized fluid;
a shutter unit of said inlet hole slidably housed within said tubular body and comprised between said inlet hole and said outlet hole;
a retaining means of said shutter unit present at said outlet hole,
a tubular flange belonging to said tubular body and arranged coaxially and radially distanced externally to said outlet hole, said tubular flange being provided internally with a shaped zone configured to house a manoeuvring key, said shaped zone being arranged coaxially and above said retaining means, said retaining means comprising:
a retaining edge realized in said tubular body and projecting towards the inside of said outlet hole;
a retaining ring arranged inside said tubular body and placed close to said retaining edge,
said retaining edge being obtained through bending by plastic deformation of the end edge of said outlet hole towards the outlet of said same outlet hole.

2. The safety valve according to claim 1, wherein said shutter unit comprises: a shutter configured to cooperate with said outlet hole of said tubular body and elastic means interposed between said shutter and said retaining means, adapted to keep said shutter in the position in which it normally closes said outlet hole.

3. The safety valve according to claim 1, wherein said tubular flange comprises:
an annular perimeter edge inside which there is said shaped zone configured to house said manoeuvring key;
an annular strip comprised between said tubular body and said annular perimeter edge, arranged peripherally and radially distanced from said outlet hole and from said retaining means;
a threaded zone realized outside said annular strip.

4. The safety valve according to claim 1, wherein said inlet hole, said outlet hole and said tubular body are coaxial to one another according to said longitudinal axis defined by said tubular sleeve.

5. The safety valve according to claim 1, wherein said shaped zone has a female polygonal profile configured to receive the insertion of a manoeuvring key having a male polygonal profile.

6. The safety valve according to claim 2, wherein said shutter comprises:
a sealing gasket placed in contact with a sealing edge made in said tubular body and turned towards the inside of said tubular body;
a gasket holder provided with an internal seat in which said sealing gasket is housed, slidably associated internally with said tubular body and arranged between said sealing gasket and said elastic means.

7. The safety valve according to claim 6, wherein said gasket holder has a polygonal external profile and said tubular body has a circular shaped internal cross section.

8. The safety valve according to claim 6, wherein said sealing edge has a shaped profile turned towards the inside of said tubular body and having the vertex in contact with said sealing gasket.

9. The safety valve according to claim 2, wherein said elastic means comprise at least one helical spring.

10. The safety valve according to claim 1, further comprising an annular seat realized circumferentially outside said tubular flange and configured to house a sealing ring.

11. A radiator comprising one or more safety valves, wherein said one or more safety valves are of the type according to claim 1.
